(19) United States
(12) Patent Application Publication
(10) Pub. No.: US 2025/0291459 A1
(43) Pub. Date: Sep. 18, 2025

(54) PLUGGABLE CONTEXTUAL NAVIGATION FOR EMBEDDED ANALYTICS INTEGRATION

(71) Applicant: SAP SE, Walldorf (DE)

(72) Inventors: Arpitha A. Shetty, Dakshina Kannada (IN); Aneesh Shukla, Bangalore (IN); Siddharth Gupta, Bangalore (IN); Mahesh Sivasubramani, Bangalore (IN); Sanjay S, Bangalore (IN)

(21) Appl. No.: 18/602,546

(22) Filed: Mar. 12, 2024

(51) Int. Cl. G06F 3/0482; G06F 3/0484

(52) U.S. Cl. CPC G06F 3/0482; G06F 3/0484

(57) ABSTRACT

Systems and methods described herein relate to contextual navigation for embedded analytics integrations. An embedded analytics user interface is presented within a first application. The embedded analytics user interface is provided by a second application and includes a plurality of user-selectable data items of the second application. A user selection of a first data item from among the plurality of user-selectable data items is detected via the embedded analytics user interface. Context data related to the user selection is identified. The context data is identified based at least partially on a stored mapping between the first data item of the second application and a second data item of the first application. One or more navigation options associated with the context data are obtained from the first application. An interface element that includes the one or more navigation options is presented within the embedded analytics user interface.

### TECHNICAL FIELD

The subject matter disclosed herein generally relates to data analytics tools. More specifically, but not exclusively, the subject matter relates to contextual navigation for embedded analytics tools.

### BACKGROUND

An embedded analytics tool may include a software component or system that is integrated into another application to provide data analysis capabilities within a context of the other application. The other application can be referred to as the “host application” or “parent application.” In some cases, although the embedded analytics tool is provided by a different application, its views and features are integrated into the host application so as to appear as a native part of the host application. This can allow a user of the host application to access analytical data related to the host application without the need to switch to a separate analytics platform.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment that includes an analytics system providing an analytics application that can be embedded into various other applications, according to some examples.

FIG. 2 is a block diagram illustrating components of an analytics system, and further illustrating interactions between the analytics system, a database system, and a first application, according to some examples.

FIG. 3 is a flowchart illustrating operations of a method suitable for providing contextual navigation options in an embedded analytics environment, according to some examples.

FIG. 4 is a flowchart illustrating operations of a method suitable for contextual navigation in an embedded analytics environment, according to some examples.

FIG. 5 is a user interface diagram illustrating an embedded analytics user interface that is presented within a context of a first application, and further illustrating a menu that is dynamically populated with a navigation extension, according to some examples.

FIG. 6 is a user interface diagram illustrating the embedded analytics user interface of FIG. 5, and further illustrating a submenu that is dynamically populated with navigation options, according to some examples.

FIG. 7 is a block diagram showing a software architecture for a computing device, according to some examples.

FIG. 8 is a block diagram of a machine in the form of a computer system, according to some examples, within which instructions may be executed for causing the machine to perform any one or more of the methodologies discussed herein.

### DETAILED DESCRIPTION

A technical challenge lies in providing relevant context between the host application and the embedded analytics tool. For example, when the user selects a data point presented via a user interface of the embedded analytics tool, the embedded analytics tool might lack sufficient contextual information to identify the intent behind the user's selection, thus limiting the scope of further interactions that can be provided in response to the selection. Moreover, the embedded analytics tool and the host application may utilize different data models, making it challenging for them to communicate relevant contextual information. As a result, the user may be obliged to manually correlate and navigate between data points provided by the embedded analytics tool and features of the host application. This may result in a disjointed workflow that is time-consuming and error-prone, reducing efficiencies or user experience.

Examples described herein address one or more technical challenges associated with embedded analytics tools by enabling enhanced contextual navigation. In some examples, a flexible extension framework is utilized to register navigation extensions for host applications, allowing each host application to provide relevant and tailored navigation options to a user while the user is interacting with an embedded analytics tool within a context of the respective host application. Where a user interacts with a data point provided by an embedded analytics tool, examples described herein provide an efficient technique for the embedded analytics tool, through communication with the host application, to present contextually relevant navigation options that enable the user to quickly reach a desired destination outside of the embedded analytics environment.

An example method may include presenting an embedded analytics user interface within a first application. The embedded analytics user interface is provided by a second application (e.g., by a cloud-based analytics tool) and includes a plurality of user-selectable data items. For example, the embedded analytics tool presents a chart or table with selectable data points.

As used herein, the term “embedded analytics user interface” may include a graphical component of an embedded analytics tool that users interact with directly within a host application. An embedded analytics user interface may include elements such as charts, tables, or other data visualization components that users can engage with to analyze data. Examples of such interfaces that can be provided by embedded analytics tools include dashboards, reports, or data visualizations that are placed within enterprise resource planning (ERP) systems, customer relationship management (CRM) software, human resource (HR) software, or financial management software. For example, within a financial management application, an embedded analytics user interface of an embedded analytics tool might present a dashboard summarizing sales performance, financial performance indicators, or inventory levels, allowing users to drill down into the data without leaving the financial management application.

The method may further include detecting, via the embedded analytics user interface, a user selection of a first data item from among the plurality of user-selectable data items. In response to detecting the user selection of the first data item, a system as described herein may identify context data. The context data may be identified based at least partially on a stored mapping between the first data item selected by a user and a second data item of the first application. In some examples, the stored mapping defines relationships between the plurality of user-selectable data items in the embedded analytics user interface and corresponding fields utilized by the first application.

For example, a user selects a data point in the embedded analytics user interface of a financial management application (as an example of the first application). Since the data point is provided by the second application, the stored mapping is used to identify a field that is utilized by the first application and that corresponds to the selected data point. This enables the system to collect or generate context data to provide to the first application regarding the user selection.

As used herein, the term “context data” may include information related to a user's interaction with an embedded analytics tool that can be understood or interpreted by the host application. Context data may include various data items that are generated or collected based on the user's activities within the embedded analytics user interface, such as selections of data items, categories or entities that relate to such selections, applied filters, or specific points of interest within a data visualization. The context data may be collected or generated and then communicated to the host application, enabling it to respond with appropriate actions or navigation options that are pertinent to the user's interaction.

For example, if a user selects a data point representing a particular product's sales figures within the embedded analytics user interface, the context data sent to the host application might include a product identifier and a time period of the sales, or other related dimensions or measures that were in focus. The context data may be provided according to a data model of the host application to ensure that the context data can be interpreted and utilized by the host application.

The method may further include obtaining, from the first application, one or more navigation options associated with the context data. The one or more navigation options may be presented in an interface element within the embedded analytics user interface. Accordingly, in some examples, the context data bridges analytical insights provided by an embedded application with actionable outcomes in the context of its host application.

In some examples, the first application is able to identify one or more intents by analyzing the context data. The one or more navigation options may correspond to such one or more intents.

The one or more navigation options may be provided by a navigation extension that is recorded for the first application by an extension framework. In some examples, the extension framework further records the navigation extension for each of a plurality of other applications that utilize the embedded analytics user interface.

The method may include checking whether a navigation extension exists for the first application, and only presenting the navigation extension (e.g., a selectable navigation extension element) or navigation options in the embedded analytics user interface if the navigation extension exists. The extension framework may thus provide a “pluggable” component for enhanced contextual navigation. In some examples, where no navigation extension is registered, the embedded analytics user interface presents default options to the user within a menu, while if the navigation extension is registered, the embedded analytics user interface dynamically populates the menu with an additional option in the form of a navigation extension element.

A navigation extension may provide an additional navigational capability based on user interactions with analytics content. The navigation extension is context-aware, presenting options that are relevant to the specific data item or visualization the user is interacting with, thereby streamlining a workflow or enhancing user experience. A navigation option may include a specific, actionable choice presented to a user within an embedded analytics tool that facilitates movement to a different view, module, section, or functionality based on the user's current context or task.

In some examples, the method includes detecting, via the embedded analytics user interface, a user selection of one of the navigation options. In response to detecting the user selection, the system triggers navigation away from the embedded analytics user interface to a target destination associated with the first navigation option. Navigation options may include in-application navigation where the user is navigated to another section of the first application or cross-application navigation where the user is navigated to a third application.

As mentioned, the one or more navigation options are presented in an interface element. The interface element may comprise a menu presented within the embedded analytics user interface. In some examples, the menu is dynamically populated with the one or more navigation options obtained from the first application. Where the navigation options are provided by the navigation extension that is recorded for the first application, the one or more navigation options are obtained from the first application based on detection of the navigation extension. In some examples, a navigation extension element is first presented within a menu (e.g., as a “jump to” button), after which a submenu presents the one or more navigation options in dependence on the navigation extension element.

As mentioned, the stored mapping may allow the second application to identify a field that is utilized by the first application and that is related to the selected first data item. The second data item may thus be a field identifier utilized by the first application. In some examples, the context data includes the field identifier. The context data may also include the user selection (e.g., the specific data item selected by the user).

In some examples, the embedded analytics user interface is embedded within a section of the first application, and the embedded analytics user interface provides at least one of a report, a dashboard, or a data visualization within the section of the first application. In a web application context, the embedded analytics user interface can, for example, be embedded via an inline frame (iframe).

Obtaining the one or more navigation options from the first application may include generating a payload that comprises the context data, and causing transmission, to the first application, of a request message (e.g., a “postMessage” in a web application context) that comprises the payload. The method may include accessing a response message (e.g., a “postMessage”) from the first application that identifies the one or more navigation options, with the first application having processed the payload of the request message to generate the one or more navigation options. Similarly, when a navigation option is subsequently selected within the embedded analytics user interface, a message may automatically be constructed and transmitted to the first application to cause navigation to a target destination associated with the navigation option.

Examples described herein may improve the functioning of an embedded analytics tool by enabling it to surface and act upon context-sensitive navigation options. Examples described herein may also provide one or more technical solutions.

An embedded analytics tool may present challenges in offering a fluid and context-aware user experience. Specifically, since the embedded analytics tool and the host application may have different data models or contextual information structures, it may be challenging to provide intuitive and context-sensitive navigation from an embedded analytics user interface to relevant areas within a host application (or across different applications). A user may have to switch between different applications to access analytical insights and then manually navigate back to their operational tasks. Examples described herein address or alleviate this problem by providing an embedded analytics tool that is able to detect user selections and, using a stored mapping, identify context data related to the selection. The embedded analytics tool can then obtain relevant navigation options from the first application for presentation to the user.

When using an analytics tool, a user may need to interpret data, understand its implications within the context of their business processes, and then decide which corresponding actions to look for within the associated host application. This process can be inefficient or susceptible to human error. Examples described herein incorporate intent management within an analytics system to automatically surface navigation options that are relevant to identified intents, within the analytics tool of the user. This can provide a user with a more intuitive and error-free user experience, guiding them to appropriate next steps based on the analytical context. Furthermore, this provides enhanced integration between an analytics tool and a host application, reducing fragmentation and creating a unified user experience (e.g., by dynamically populating menus and submenus with contextually relevant navigation options without requiring the user to navigate to a different view or section).

In some examples, an embedded analytics tool is integrated with multiple different host applications. For example, an HR application, a financial management application, and an ERP system might each leverage data visualization features provided by the embedded analytics tool by integrating embedded analytics user interfaces into their respective workflows. Examples described herein may enhance the technical capabilities of such implementations by adding a “pluggable” contextual analytics module to the embedded analytics tool. Such a module can be dynamically registered and integrated with a variety of different designer tools or host applications using an extension framework. For instance, an intent management component can automatically communicate with different host applications to obtain and present navigation options that are directly applicable to the respective contexts of their users. This “pluggability” may also reduce developer effort, such as by providing a central connection point to minimize changes to be made to host applications.

When the effects in this disclosure are considered in aggregate, one or more of the methodologies described herein may obviate a need for certain efforts or resources that otherwise would be involved in providing or operating embedded analytics tools. Computing resources utilized by systems, databases, or networks may be more efficiently utilized or reduced, e.g., as a result of a reduced number of user selections needed to navigate to a desired destination. Examples of such computing resources may include processor cycles, network traffic, memory usage, graphics processing unit (GPU) resources, data storage capacity, power consumption, and cooling capacity.

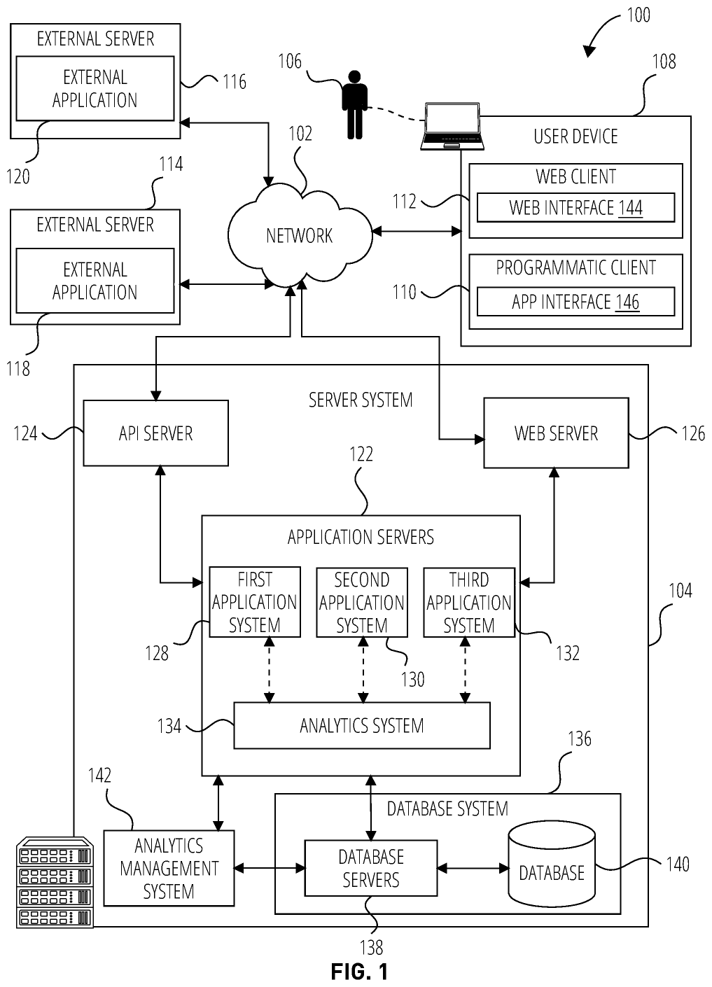

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 108 that is accessed by a user 106. A web client 112 (e.g., a browser) or a programmatic client 110 (e.g., an “app”) may be hosted and executed on the user device 108.

An Application Program Interface (API) server 124 and a web server 126 provide respective programmatic and web interfaces to components of the server system 104. One or more application servers 122 host a first application system 128, a second application system 130, a third application system 132, and an analytics system 134, each of which includes one or more components, modules, or applications. In some examples, and as shown in FIG. 1, the server system 104 also includes an analytics management system 142 that provides certain back-end support functionality to the analytics system 134.

The user device 108 can communicate with the application servers 122, for example, via the web interface supported by the web server 126 or via the programmatic interface provided by the API server 124. It will be appreciated that, although only a single user device 108 is shown in FIG. 1, a plurality of user devices may be communicatively coupled to the server system 104 in some examples. Further, while certain functions may be described herein as being performed at either the user device 108 (e.g., web client 112 or programmatic client 110) or the server system 104, the location of certain functionality either within the user device 108 or the server system 104 may be a design choice.

The application servers 122 are communicatively coupled to database servers 138, facilitating access to one or more information storage repositories, such as a database 140, within a database system 136. In some examples, the database 140 includes storage devices that store information to be processed by the first application system 128, second application system 130, the third application system 132, the analytics system 134, or the analytics management system 142.

The application servers 122 accesses application data (e.g., application data stored by the database servers 138) to provide applications or software tools to the user device 108 via a web interface 144 or an app interface 146. For example, the first application system 128, the second application system 130, and the third application system 132 respectively provide business-related applications to the user 106, such as an HR application, an ERP application, and a financial management application, respectively. The analytics system 134 provides an analytics application, features of which can be embedded into applications provided by the first application system 128, the second application system 130, or the third application system 132, thereby providing an embedded analytics tool.

To illustrate certain features, examples that follow describe a first application provided by the first application system 128 as a host application in which the analytics application of the analytics system 134 is embedded. However, it will be appreciated that such an embedded analytics tool can be embedded in multiple applications, each with different features or functionality. For example, the embedded analytics tool can also be integrated into an application provided by the second application system 130 and an application provided by the third application system 132.

Referring now to the analytics system 134, the analytics system 134 may form part of a cloud product offered as software as a service (SaaS) for one or more of business intelligence (BI), planning, and predictive analytics. The analytics system 134 may provide a user interface that enables users to interact with and visualize data through various analytical tools and representations. In some examples, the user device 108 can access the analytics system 134 directly (e.g., via a dedicated web application) or as an embedded analytics tool integrated into another application (e.g., via a web application provided by the first application system 128).

The embedded analytics tool provided by the analytics system 134 is configured to integrate with a host application (e.g., the first application system 128) using an embedding framework that allows for the insertion of analytical content directly into a context or user interface of the host application. This integration facilitates the display and interaction with data visualizations, dashboards, or reports without the need for users to exit their primary application environment.

In some examples, the first application of the first application system 128 can be accessed via the web interface 144 or app interface 146, and includes analytics features provided by a dedicated instance of the service or application provided by the analytics system 134. In some examples, a live connection is established between the analytics system 134 and data storage associated with the first application system 128 (e.g., the database 140), enabling real-time data access and manipulation, ensuring that the analytics service within the host application has the most current and relevant data.

Interaction between the embedded analytics tool and its host application may occur through a series of messages and API calls (e.g., browser-side messages between the respective applications at the web client 112 as well as API calls between the respective systems at the server side). This enables data exchanges to transfer context-specific information between the embedded analytics tool and the host application, as described in greater detail elsewhere. For example, when a user selects a data point within an embedded analytics user interface provided by the analytics system 134, the analytics system 134 identifies relevant context data and communicates this information to the corresponding host application (e.g., the first application of the first application system 128). This allows the host application to respond with appropriate actions or additional data that is pertinent to the selected context, thereby providing a cohesive or more integrated user experience.

The analytics system 134 may also be accessed by users to design features, such as reports or dashboards, to be presented in an embedded analytics user interface. Such features can be referred to as “stories.” For example, while the user 106 is navigating the first application, the user 106 may select a “financial report” option, which triggers presentation, via the embedded analytics user interface, of a predesigned story that provides certain data visualizations (populated with, for example, the latest data from the database 140).

The analytics management system 142 may provide components that facilitate the creation, management, and deployment of analytical content across various applications. For example, the analytics management system 142 can provide tools and services that enable the analytics system 134 to function effectively when its features are integrated into host applications. This may include backend processes, such as data querying, intent management, and context determination. The analytics management system 142 may be responsible for database access, providing a robust and secure environment for handling sensitive business data and ensuring that the analytical capabilities are consistently available to users across different application contexts.

In some examples, the analytics system 134 or the analytics management system 142 operate to provide an extension framework for registering context-aware navigation extensions. In this context, an extension framework may include a set of software tools and protocols that allows for modular addition of new features or components to an existing system, providing a structured way to extend the functionality of an application without significantly altering its core architecture. For example, the extension framework can be used to register a “jump to” navigation extension for the first application of the first application system 128, which can then be “plugged” into the embedded analytics user interface of the first application based on predetermined rules. When the navigation extension is triggered during operation, it may cause context-sensitive navigation options to be presented to the user 106 within the embedded analytics user interface, as described in greater detail elsewhere.

In some examples, the application servers 122 are part of a cloud-based platform provided by a software provider that allows the user 106 to utilize the tools of the first application system 128, the second application system 130, the third application system 132, or the analytics system 134. For example, an account holder of the software provider may have access to the respective applications provided by the aforementioned systems to utilize their functionality via the network 102.

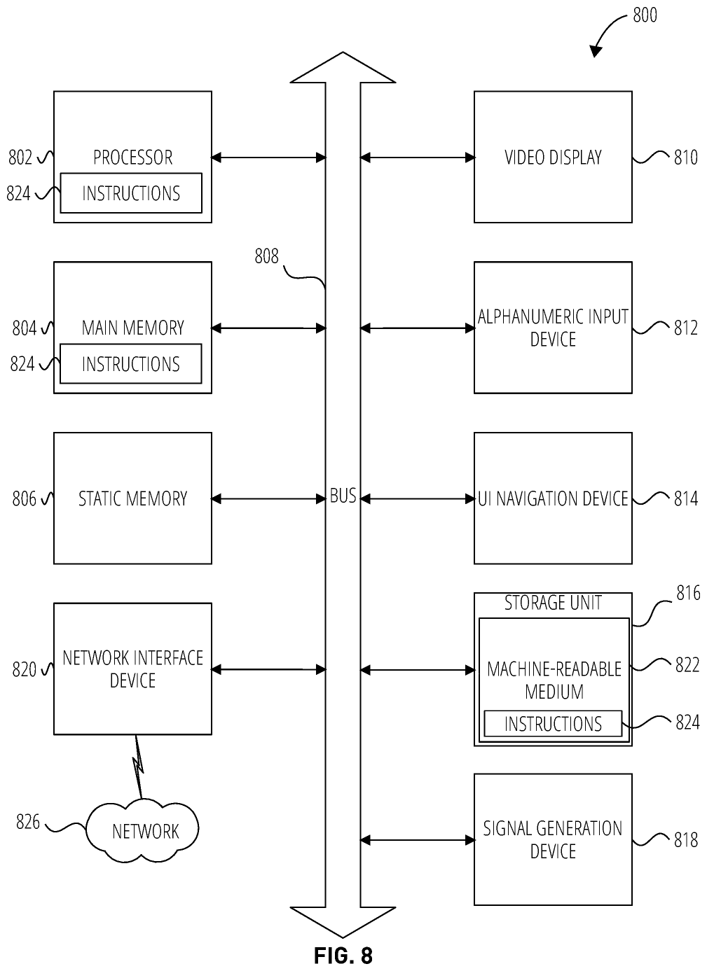

One or more of the application servers 122, the database servers 138, the API server 124, the web server 126, the first application system 128, the second application system 130, the third application system 132, the analytics system 134, or the analytics management system 142 may each be implemented in a computer system, in whole or in part, as described below with respect to FIG. 8. In some examples, external applications, such as an external application 118 executing on an external server 114 and external application 120 executing on an external server 116, can communicate with the application servers 122 via the programmatic interface provided by the API server 124.

For example, a third-party application may support one or more features or functions on a website or platform hosted by a third party, or may perform certain methodologies and provide input or output information to the application servers 122 for further processing or publication. As an example, the analytics system 134 can not only be linked to “internal” host applications such as the first application of the first application system 128, but can also be linked to the external application 120 to provide embedded analytics within the external application 120. In this way, users may leverage features of the analytics system 134 within their own (e.g., custom) host applications.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

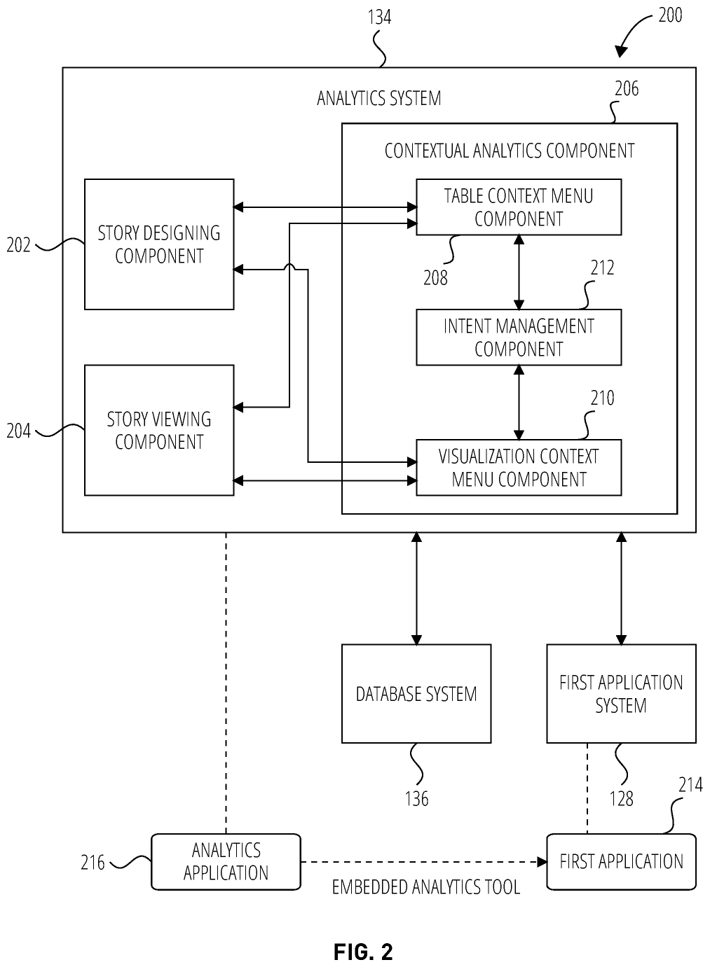

FIG. 2 is a diagram 200 illustrating components of the analytics system 134 of FIG. 1, and also illustrating interactions between the analytics system 134 and the database system 136 of FIG. 1, as well as interactions between the analytics system 134 and the first application system 128 of FIG. 1, according to some examples. FIG. 2 further illustrates the first application 214 of the first application system 128 (as an example of a host application) and the analytics application 216 of the analytics system 134, features of which are provided within the first application 214 via an embedded analytics user interface.

In FIG. 2, the analytics system 134 is shown to include a story designing component 202 and a story viewing component 204, as well as a contextual analytics component 206 that includes a table context menu component 208, a visualization context menu component 210, and an intent management component 212. It is noted that, in some examples, one or more of the aforementioned components may be provided by the analytics management system 142 of FIG. 1 in communication with the analytics system 134.

The story designing component 202 allows users to build and modify stories, such as charts and tables that are integrated into host applications. For example, the story designing component 202 causes one or more stories to be embedded into the first application 214 via the analytics application 216 of the analytics system 134.

Stories may include various other features, such as filtering, ranking, and sorting features. A story may include various interactive elements that help to construct a narrative around data of the host application. During operation, the analytics application 216 provides data analytics features within the first application 214 based on the design facilitated by the story designing component 202.

The story viewing component 204 may provide users with access to stories. For example, the story viewing component 204 can be responsible for generating interfaces through which users view and interact with analytical content created using the story designing component 202. In some examples, where the analytics system 134 embeds stories into a host application, the story viewing component 204 provides the stories in an embedded analytics user interface within the host application. The story viewing component 204 renders the stories for consumption, maintaining the design and interactivity specified by designers. In some examples, users can explore the data, apply filters, or drill down into specific details within the visualizations.

In some examples, the story designing component 202 and the story viewing component 204 communicate with the contextual analytics component 206 to provide or enable context-sensitive functionalities within the stories being designed or presented. The contextual analytics component 206 can be connected to (e.g., “plugged” into) various components to provide contextual navigation abilities. In FIG. 2, the contextual analytics component 206 is connected to the story designing component 202 and the story viewing component 204 to enable contextual navigation features therein for tables and data visualizations (e.g., charts). It is noted that the table context menu component 208 and the visualization context menu component 210 are merely presented as examples to illustrate context-aware navigation options relating to tables and data visualizations, respectively.

In some examples, the contextual analytics component 206 can be dynamically connected to (e.g., “plugged” into) other tools. For example, in addition to story designing component 202, the contextual analytics component 206, the contextual analytics component 206 could be connected to a mobile software development kit (SDK) to allow developers using the mobile SDK to leverage the extension framework.

The table context menu component 208 provides users with context-sensitive options when interacting with tabular data within an embedded analytics user interface of the analytics application 216 that is presented in the first application 214. For example, when a user right-clicks or otherwise interacts with a data point in a table, the table context menu component 208 presents a menu of available actions or navigational options that are relevant to the selected data point. Such a menu can be referred to as a context menu. The table context menu component 208 may work with the intent management component 212 to dynamically generate or populate these options based on context data. Similar to the table context menu component 208, the visualization context menu component 210 offers contextual actions when users interact with data visualizations, such as charts or graphs.

In some examples, the intent management component 212 manages logic and data flow for intent-based interactions using context data. The intent management component 212 interprets a user's actions within an analytics context and determines appropriate context data to be communicated with external systems or applications (e.g., an application external to the analytics system 134). The intent management component 212 may orchestrate the exchange of information between the analytics system 134 and the database system 136 to collect information, and between the analytics system 134 and the relevant host application (e.g., the first application 214) to obtain actions, such as navigation options, relating to context data.

During operation, when a user selects a data item in a story (e.g., a data point in the embedded analytics user interface within the first application 214), the intent management component 212 communicates with the database system 136 to retrieve a data item of the first application 214 that corresponds to the selected data item of the analytics application 216. For example, the database system 136 stores a mapping comprising relationships between user-selectable data items in the embedded analytics user interface and corresponding fields utilized by the first application 214. In this way, the intent management component 212 obtains a field identifier that can be utilized by the first application 214 and that is associated with the user-selected data item.

A field identifier may be a unique label or key used to reference a specific field within a dataset or database schema of the first application system 128. For example, if the first application system 128 is a CRM system, a field identifier might be “PRODUCT_ID” which has a value that uniquely identifies a product (the value may be the data item that the user selected). The stored mapping can then allow the intent management component 212 to match the data item selected by the user, such as the name of the product on a bar chart generated by the analytics application 216, with the correct field identifier (“PRODUCT_ID”) used by the first application 214. By including the field identifier in context data sent to the host application, the host application is enabled to provide navigation options directly related to that attribute. For example, if the field identifier corresponds to a product identifier field, the host application might offer options to navigate to inventory levels for that product, initiate a reorder process, or view marketing campaigns for the product.

The intent management component 212 generates or collates the context data to send to the first application 214 (e.g., to the first application system 128). The context data may include one or more of the field identifier, the first data item, a semantic object utilized by the first application, a data source identifier associated with the first data item, or other data that is relevant to the user selection and that can be interpreted by the first application 214. In some examples, the field identifier is used by the intent management component 212 to gather additional context data from the database system 136.

A semantic object may include a conceptual representation of a business entity or process that provides a meaningful context to data points or user actions. For instance, a semantic object in a logistics application might represent a shipment, encapsulating attributes such as shipment identifier, origin, destination, and status. Based on the user selection in the embedded analytics user interface, the intent management component 212 can obtain the semantic object associated with the user selection. Including a semantic object in context data may enable a host application to infer the user's navigation interest. For example, if the semantic object is “customer,” the host application may determine that the user is interested in customer-related data and offer navigation options such as viewing customer profiles, viewing customer transaction history, or viewing customer support tickets.

A data source identifier may include a unique identifier that specifies the origin of a particular set of data within an analytics environment. For example, if the data source identifier indicates that the user selection within the embedded analytics user interface relates to a “Sales Data” data source, the host application may determine that the user should be presented with navigation options that lead to further sales analysis or forecasting.

During operation, a user of the first application 214 interacts with the analytics system 134 via an embedded analytics user interface to access, for example, analytical stories and reports, and to leverage the context-aware functionalities provided by the contextual analytics component 206. The contextual analytics component 206 enables the first application 214 to “understand” the context of a selection made by the user, even though the user made the selection in the embedded analytics user interface provided by the analytics application 216. The first application 214 can then also predict or infer the user's intent and present suitable navigation options that are presented directly within the embedded analytics user interface, without the user having to navigate away from the embedded analytics user interface.

In some examples, the contextual analytics component 206 utilizes an extension framework to enable the integration of navigation extensions, such as a “jump to” option or a “contextual analytics” function. For example, the first application 214 can register a navigation extension via the extension framework. For instance, a “jump to” option can be registered for tables generated within the embedded analytics user interface of the first application 214.

Subsequently, when a user makes a selection of a data item in a table, the intent management component 212 automatically detects the presence of the navigation extension and presents a “jump to” option to the user. The intent management component 212 causes communication with the first application system 128 to obtain the navigation options associated with the selected data point, and then presents these in dependence on the navigation extension. If no navigation extension is detected, the intent management component 212 does not cause presentation of such options.

In some examples, the extension framework can be used to conveniently register navigation extensions for multiple applications, such as applications of the second application system 130 and the third application system 132 of FIG. 1, respectively. In this way, the contextual analytics component 206 provides a unified module that can be leveraged across multiple host applications.

As mentioned, the contextual analytics component 206 can be “plugged” into various components or layers, allowing navigation extensions to be available across various parts of an embedded analytics tool (e.g., not only for tables, but also for other visualization types). As a result, a developer can create an extension once and deploy them across multiple system components or layers, reducing the time and resources needed for development and maintenance. In this way, an embedded analytics tool can be enhanced with customizable and consistent navigation and contextual analysis features.

In some examples, at least some of the components shown in FIG. 2 are configured to communicate with each other to implement aspects described herein. One or more of the components described herein may be implemented using hardware (e.g., one or more processors of one or more machines) or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

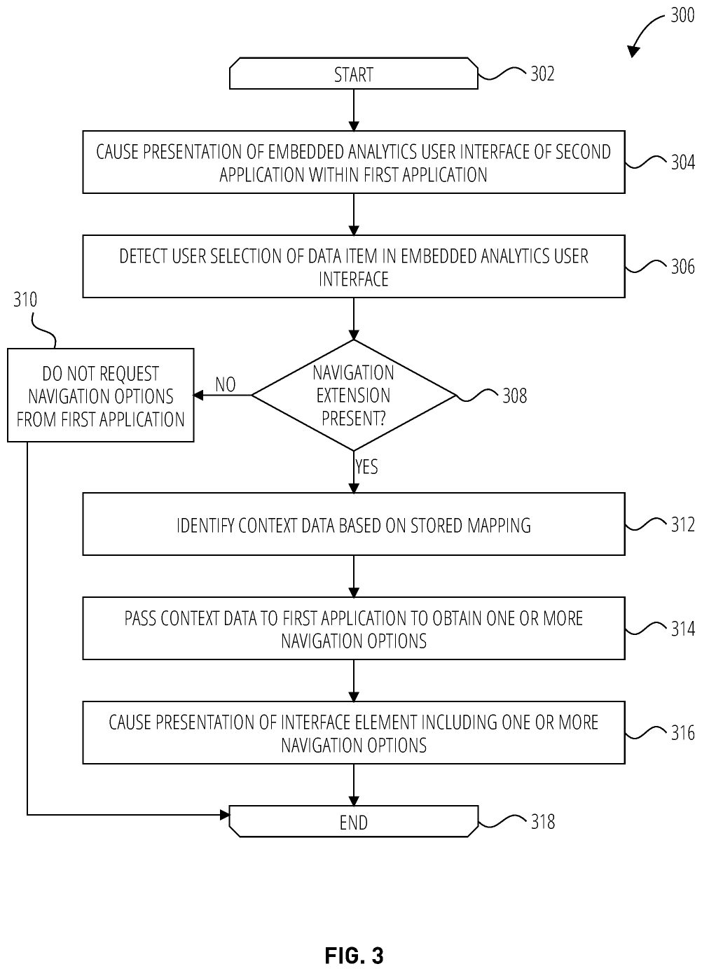

FIG. 3 is a flowchart illustrating operations of a method 300 suitable for providing contextual navigation options in an embedded analytics environment, according to some examples. By way of example and not limitation, aspects of the method 300 may be performed by components, devices, systems, or databases shown in FIG. 1 and FIG. 2.

The method 300 commences at opening loop element 302 and proceeds to operation 304, where the analytics system 134 causes presentation of an embedded analytics user interface of a second application within a first application. The analytics application 216 and the first application 214 of FIG. 2 are used as non-limiting examples of the second application and the first application, respectively, in the description that follows. For example, the user 106 uses their user device 108 to access the first application 214 via the web client 112. The story viewing component 204 of the analytics application 216 enables the embedded analytics user interface to be rendered in the context of the first application 214. In this way, the user 106 may experience the embedded analytics user interface as if it is a native part of the first application 214.

A plurality of data items is presented within the embedded analytics user interface. For example, in a scenario where the first application 214 is an HR application, the user 106 might be an HR manager using the first application 214 to review a dashboard of employee data. The dashboard is embedded in the embedded analytics user interface provided by the analytics system 134. The dashboard may include various data points, such as job titles, department information, employee names, and employee identifiers. The dashboard may include tables and visualizations, such as charts.

In some examples, when the story viewing component 204 loads the embedded analytics user interface, the contextual analytics component 206 checks whether a navigation extension is registered for the first application 214 (or for the specific story within the first application 214). If so, the analytics system 134 determines that the navigation extension should be triggered if the user 106 selects one or more data items within the embedded analytics user interface. For example, the navigation extension can involve displaying a “jump to” option, as further described below. In other examples, the first application 214 only checks for the presence of a navigation extension in response to a particular user selection (as opposed to checking when the story is loaded).

As described elsewhere, the analytics system 134 may implement an extension framework that enables the analytics system 134 to determine whether a navigation extension is registered for a particular first application 214. The extension framework may dictate that, if such a navigation extension is registered, additional, context-sensitive options should be dynamically provided to the user 106. A developer may register the relevant navigation extension when designing or implementing a story for the embedded analytics user interface.

The user 106 selects a data item in the embedded analytics user interface. For example, the HR manager right-clicks on the job title “Software Engineer,” which they are interested in analyzing further. At operation 306, the analytics system 134 then detects the user selection of this data item. The intent management component 212 of the analytics system 134 checks whether a navigation extension is present.

If, at decision operation 308, the analytics system 134 determines that no navigation extension exists, the method 300 proceeds to operation 310, where the analytics system 134 does not cause any navigation extension to be rendered and does not communicate with the first application 214 to obtain navigation options for a navigation extension. For example, the analytics application 216 may then simply display a standard or default menu with options presented in response to the right-clicking operation, without adding a navigation extension element.

On the other hand, if, at decision operation 308, the analytics system 134 determines that a navigation extension exists for the first application 214 or for the specific user action within the first application 214, the method 300 proceeds to operation 312, where the analytics system 134 gathers context data. For example, the “jump to” option is displayed in a first menu, and then analytics system 134 queries the database system 136 using the selected data item (e.g., the title “Software Engineer”) to obtain further information to be presented in association or dependence on the “jump to” option.

In some examples, based on a stored mapping in the database system 136, the analytics system 134 determines that the selected data item corresponds to a particular field identifier. For example, the stored mapping indicates that “Software Engineer” corresponds to the “JOB_TITLE_ID” field identifier which is used by the first application 214. The database 140 may further indicate a value corresponding to “Software Engineer” in the data model of the first application 214, such as “ENG_Software.” This information may be used as context data for processing by the first application 214. In other words, operation 312 allows the first application 214 to understand what the data point “Software Engineer,” as generated by the analytics application 216, means or represents within the context of the first application 214.

The context data is passed to the first application 214 at operation 314. For example, a “postMessage” call (e.g., a request message) may be generated that has a payload containing the context data. In some examples, the intent management component 212 builds the relevant message and causes it to be transmitted to the first application 214.

The payload of the call generated and sent to the first application 214 during operation 314 can include, for example, one or more of:
The field identifier (e.g., “JOB_TITLE_ID”);
The data item selected by the user (e.g., “Software Engineer”);
The value for the field in the context of the first application 214 (e.g., “ENG_Software”);
A semantic object in the context of the first application 214 (e.g., “JobTitle”); or
A data source identifier indicating a data source upon which the analytics application 216 built the data item (e.g., “Job Data Tables”).

The first application 214 then responds with the details that should be presented to the user 106, such as one or more navigation options to display in a submenu corresponding to the “jump to” option in the menu. For example, the first application 214 sends a “postMessage” response that can include, for each navigation option to present to the user 106, one or more of an intent, a semantic object, a user interface text. In the example of the HR manager selecting the “Software Engineer” data point, the first application 214 might respond with the following navigation options:

### Option 1: View Employee List

Intent: view-employee˜list8D89D3856
Semantic Object: “EmployeeList”
User Interface Text: “View List of Employees”

### Option 2: Open Recruitment Data

Intent: open-recruitment-data˜8D89D3856
Semantic Object: “RecruitmentData”
User Interface Text: “Open Recruitment Data”

### Option 3: View Job Description

Intent: view-job-description˜8D89D3856
Semantic Object: “JobDescription”
User Interface Text: “See Job Description”

At operation 316, an interface element including the one or more navigation options is presented in the embedded analytics user interface at the user device 108. In this way, a contextual gap that may have existed between the first application 214 and its embedded analytics user interface can be bridged. The embedded analytics user interface of the analytics application 216 is provided with suitable navigation options based on intents recognized by the first application 214.

For example, when the “jump to” option is presented in a menu, it might have a submenu listing the options, “View Employee List,” “Open Recruitment Data,” and “View Job Description.” The HR manager thus sees a context menu pop up with the options provided by the HR application (as an example of the first application 214). In this way, the user 106 can receive options for navigating away from the embedded analytics user interface without having to switch back to a view of the first application 214. The user 106 receives relevant navigation options that correspond to their selected data items, streamlining the analytical workflow.

In some examples, the first application system 128 is configured to receive the payload of a request message and dynamically generate a response message with navigation options based on the contents of the payload. The first application system 128 may implement a rules-based system that governs the navigation option or navigation options corresponding to certain context data. Alternatively or additionally, the first application system 128 may utilize machine learning tools to generate navigation options that are appropriate for the user's selection. For example, the first application system 128 can be configured to return the three navigation options described above in response to detecting that the context data relates to a job title or position. The method 300 concludes at closing loop element 318.

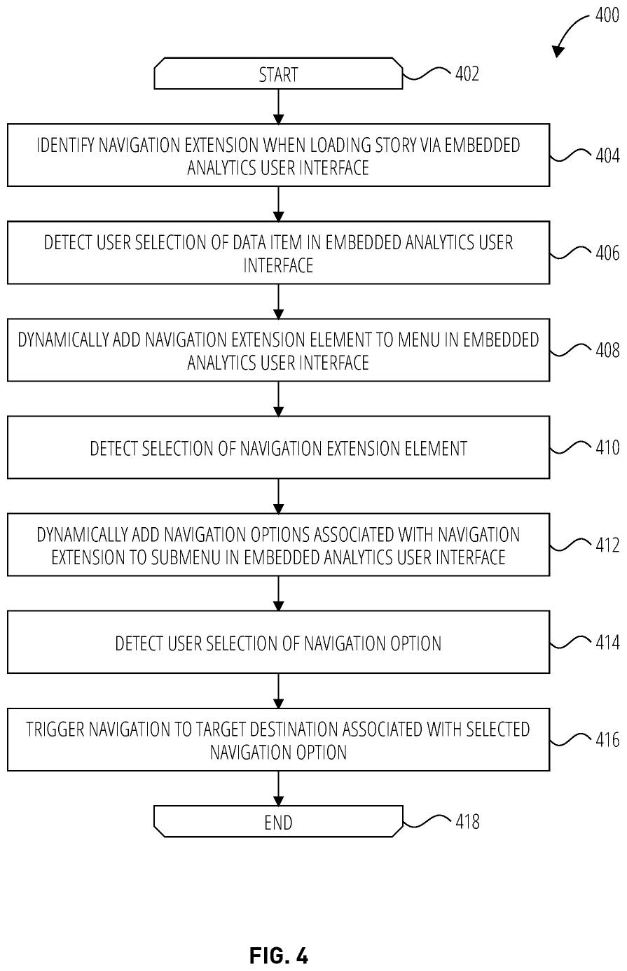

FIG. 4 is a flowchart illustrating operations of a method 400 suitable for contextual navigation in an embedded analytics environment, according to some examples. By way of example and not limitation, aspects of the method 400 may be performed by the components, devices, systems, or databases shown in FIG. 1 and FIG. 2.

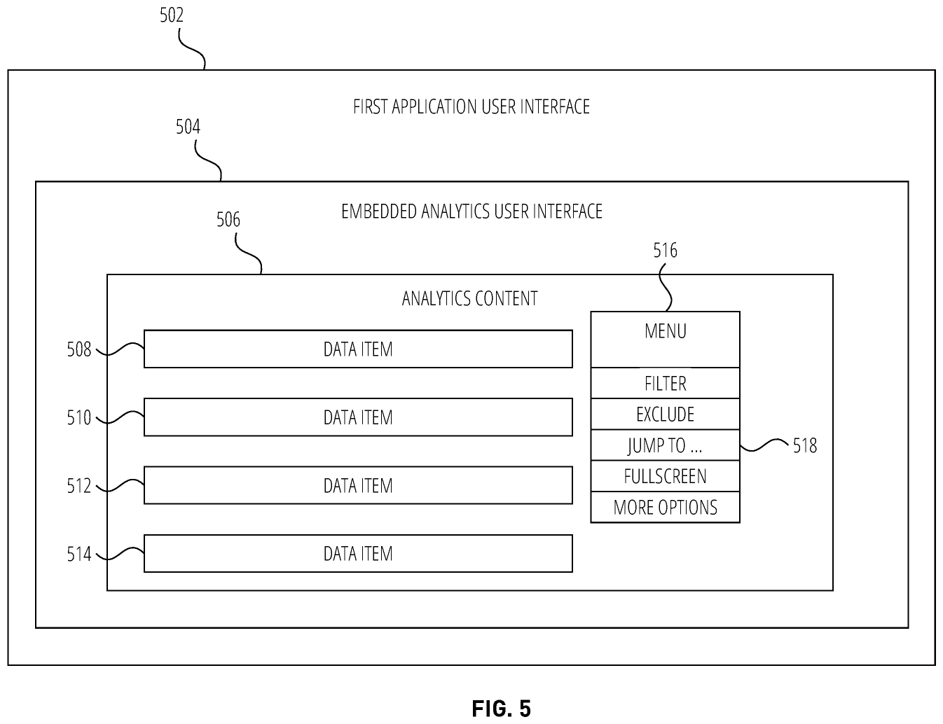

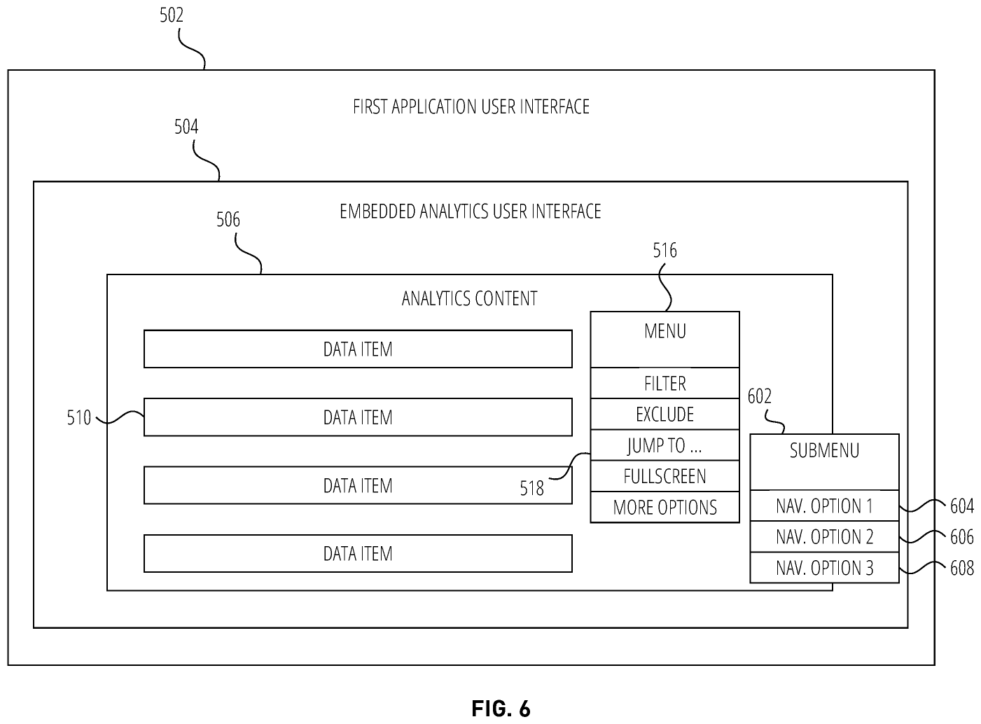

As with FIG. 3, the analytics application 216 and the first application 214 of FIG. 2 are used as non-limiting examples in the description of FIG. 4 that follows. Furthermore, the user interface diagrams of FIG. 5 and FIG. 6 are described together with the method 400 of FIG. 4 to illustrate non-limiting examples of user interface elements.

The method 400 commences at opening loop element 402 and proceeds to operation 404, where the analytics system 134 identifies, at the time of loading a story via an embedded analytics user interface within the first application 214, that a navigation extension is registered for the first application 214 or for the particular story.

The story viewing component 204 then enables the user 106 to view the story on the user device 108. FIG. 5 and FIG. 6 illustrate an embedded analytics user interface 504, according to some examples. The embedded analytics user interface 504 is displayed within a first application user interface 502 of the first application 214 (e.g., via an iframe embedding). The embedded analytics user interface 504 includes analytics content 506 that presents data items 508, 510, 512, 514 to the user 106 at the user device 108.

In FIG. 5 and FIG. 6, the first application user interface 502 represents a primary interface of a host application (e.g., the first application 214) where users perform operational tasks supported by the host application. Within the first application user interface 502, the embedded analytics user interface 504 is presented, providing users with direct access to analytical insights without the need to navigate away from the host application. It is noted that the embedded analytics user interface 504 need not necessarily be presented as shown in FIG. 5 and FIG. 6. The embedded analytics user interface may be provided as a window within a page or view of a parent application user interface, or as standalone page or view (e.g., a “full screen interface”), but within the context of the host application to allow the user 106 to leverage analytics features without having to leave the host application.

For example, in the example of an HR application, to navigate to the embedded analytics user interface 504, the user 106 might access the first application 214, navigate to a “Report Center,” and then select an “Employee Overview” report. A corresponding story is then rendered within the embedded analytics user interface 504. The embedded analytics user interface 504 may be designed to blend in with the first application 214, providing a consistent user experience.

Referring again to the HR application example, the HR manager might use the embedded analytics user interface 504 within the first application 214 to review a dashboard of employee data. The dashboard may form part of the analytics content 506 and the data items 508, 510, 512, 514 may, for example, include employee details that are shown in association with selectable employee numbers or codes.

Referring again to FIG. 4, at operation 406, the analytics system 134 detects a user selection of a data item in the embedded analytics user interface 504. For example, the HR manager right-clicks on the data item 510 which is an employee number. Based on the identified navigation extension, at operation 408, the analytics system 134 dynamically adds a navigation extension element 518 to a menu 516, and presents the menu 516 in the embedded analytics user interface (operation 408), as shown in FIG. 5. In the embedded analytics user interface 504 of FIG. 5 and FIG. 6, the navigation extension element 518 is a “jump to” option. However, other options, such as “contextual analysis,” could also be presented.

The menu 516 is dynamically populated such that, in addition to standard or default options that are provided by the analytics application 216 (“filter,” “exclude,” “fullscreen,” and “more options”), the navigation extension element 518 is included in the menu 516 to provide an additional, context-sensitive option that allows the user 106 to navigate further based on the specific context of their selection. This additional option facilitates intent-based navigation by allowing users to transition directly from a selected data item to related content or functionalities within the first application user interface 502 or other connected applications that are not part of the analytics application 216.

Referring back to FIG. 4, the user 106 then selects (e.g., clicks on or hovers over) the navigation extension element 518, and the analytics system 134 detects the selection of the navigation extension element 518 (operation 410). In response, the analytics system 134 dynamically adds one or more navigation options, obtained from the first application 214 as described elsewhere, to the embedded analytics user interface 504 at operation 412. FIG. 6 illustrates how selection of the “jump to” option of the navigation extension element 518 can lead to presentation of a submenu 602 that includes navigation options 604, 606, 608.

In some examples, the analytics application 216 is not itself configured to understand the full meaning or context of the user's initial selection (e.g., the employee number), or not itself able to map the selection to sufficient contextual information to offer intent-based navigation. Through real-time communication between the analytics application 216 and the first application 214, this deficiency may be addressed, since the first application 214 is provided with context data pertaining to the user's selection and can then provide the analytics application 216 with the necessary intent-driven options to present to the user 106 within the embedded analytics user interface 504 itself (e.g., without the user having to first navigate away from the embedded analytics user interface 504 provided by the analytics application 216).

At operation 414, the user 106 then selects one of the navigation options 604, 606, 608. For example, based on the initial selection of the employee number by the HR manager, the navigation option 604 is “View Employee Profile.” The user 106 selects the navigation option 604, which triggers navigation to a target destination associated with the navigation option 604 at operation 416.

In some examples, the analytics system 134 sends a message to the first application 214 to instruct the first application 214 to navigate the user 106 to the target destination. For example, the intent management component 212 of the analytics system 134 generates a “postMessage” that is transmitted to the first application 214, indicating that the user 106 has selected “View Employee Profile.” The first application 214 then responds with the details of the target destination, such as an employee profile page corresponding to the employee number. In this way, the user 106 can automatically be navigated away from the embedded analytics user interface 504 to a section of the first application 214.

In some examples, the dynamic integration of context-aware navigation options within the submenu 602 of the embedded analytics user interface 504 allows for a streamlined workflow, enabling users to take immediate action based on insights derived from the analytics content 506. The method 400 concludes at closing loop element 418.

Referring to FIG. 6, navigation away from the embedded analytics user interface 504 may involve in-application navigation or cross-application navigation. The first application 214 may generate a target destination that has a Uniform Resource Locator (URL) associated with another application. For example, one of the navigation options might be “See Employee Salary Details.” If the user 106 selects this navigation option, the HR application (as an example of the first application 214) can trigger navigation to a different application (not the first application 214 or the analytics application 216), such as a financial management application, to which to the user 106 is automatically navigated.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one memory that stores instructions; and one or more processors configured by the instructions to perform operations comprising: causing presentation of an embedded analytics user interface within a first application, the embedded analytics user interface being provided by a second application and including a plurality of user-selectable data items of the second application; detecting, via the embedded analytics user interface, a user selection of a first data item from among the plurality of user-selectable data items; in response to detecting the user selection of the first data item: identifying, based at least partially on a stored mapping between the first data item of the second application and a second data item of the first application, context data related to the user selection, and obtaining, from the first application, one or more navigation options associated with the context data; and causing presentation, within the embedded analytics user interface, of an interface element including the one or more navigation options.

In Example 2, the subject matter of Example 1 includes, wherein the one or more navigation options are provided via a navigation extension that is recorded for the first application by an extension framework, and the extension framework further records the navigation extension for each of a plurality of other applications that utilize the embedded analytics user interface.

In Example 3, the subject matter of any of Examples 1-2 includes, wherein the user selection is a first user selection, and the operations further comprise: detecting, via the embedded analytics user interface, a second user selection of a first navigation option from among the one or more navigation options presented within the embedded analytics user interface; and in response to detecting the second user selection, triggering navigation away from the embedded analytics user interface to a target destination associated with the first navigation option.

In Example 4, the subject matter of any of Examples 1-3 includes, wherein triggering the navigation away from the embedded analytics user interface comprises transmitting an instruction message to the first application to perform in-application navigation to the target destination, and the navigation causes presentation of a first application user interface of the first application that does not include the embedded analytics user interface.

In Example 5, the subject matter of any of Examples 1˜4 includes, wherein triggering the navigation away from the embedded analytics user interface comprises transmitting an instruction message to the first application to perform cross-application navigation to the target destination, and the navigation causes presentation of a third application user interface of a third application that does not include the embedded analytics user interface.

In Example 6, the subject matter of any of Examples 1-5 includes, wherein the interface element comprises a menu presented within the embedded analytics user interface, and the operations further comprise: dynamically populating the menu with the one or more navigation options obtained from the first application.

In Example 7, the subject matter of any of Examples 1-6 includes, wherein the one or more navigation options are provided via a navigation extension that is recorded for the first application, and the one or more navigation options are obtained from the first application based on detection of the navigation extension.

In Example 8, the subject matter of any of Examples 1-7 includes, the operations further comprising: dynamically populating a menu within the embedded analytics user interface with a navigation extension element based on the detection of the navigation extension, the interface element being a submenu of the menu that presents the one or more navigation options in dependence on the navigation extension element.

In Example 9, the subject matter of any of Examples 1-8 includes, wherein the stored mapping defines relationships between the plurality of user-selectable data items in the embedded analytics user interface and corresponding fields utilized by the first application.

In Example 10, the subject matter of any of Examples 1-9 includes, wherein the second data item is a field identifier utilized by the first application.

In Example 11, the subject matter of any of Examples 1-10 includes, wherein the context data comprises one or more of the field identifier, the first data item, a semantic object utilized by the first application, or a data source identifier associated with the first data item.

In Example 12, the subject matter of any of Examples 1-11 includes, wherein the obtaining of the one or more navigation options comprises: generating a payload that comprises the context data; causing transmission, to the first application, of a request message that comprises the payload; and accessing a response message from the first application that identifies the one or more navigation options, wherein the first application processes the payload of the request message to generate the one or more navigation options.

In Example 13, the subject matter of any of Examples 1-12 includes, wherein the embedded analytics user interface presents the plurality of user-selectable data items in at least one of a table or a chart.

In Example 14, the subject matter of any of Examples 1-13 includes, wherein the embedded analytics user interface is embedded within a section of the first application, and the embedded analytics user interface provides at least one of a report, a dashboard, or a data visualization within the section of the first application.

Example 15 is a method comprising: causing presentation of an embedded analytics user interface within a first application, the embedded analytics user interface being provided by a second application and including a plurality of user-selectable data items of the second application; detecting, via the embedded analytics user interface, a user selection of a first data item from among the plurality of user-selectable data items; in response to detecting the user selection of the first data item: identifying, based at least partially on a stored mapping between the first data item of the second application and a second data item of the first application, context data related to the user selection, and obtaining, from the first application, one or more navigation options associated with the context data; and causing presentation, within the embedded analytics user interface, of an interface element including the one or more navigation options.

In Example 16, the subject matter of Example 15 includes, wherein the one or more navigation options are provided via a navigation extension that is recorded for the first application by an extension framework, and the extension framework further records the navigation extension for each of a plurality of other applications that utilize the embedded analytics user interface.

In Example 17, the subject matter of any of Examples 15-16 includes, wherein the user selection is a first user selection, and the method further comprises: detecting, via the embedded analytics user interface, a second user selection of a first navigation option from among the one or more navigation options presented within the embedded analytics user interface; and in response to detecting the second user selection, triggering navigation away from the embedded analytics user interface to a target destination associated with the first navigation option.

Example 18 is a non-transitory computer-readable medium that stores instructions that, when executed by one or more processors, cause the one or more processors to perform operations comprising: causing presentation of an embedded analytics user interface within a first application, the embedded analytics user interface being provided by a second application and including a plurality of user-selectable data items of the second application; detecting, via the embedded analytics user interface, a user selection of a first data item from among the plurality of user-selectable data items; in response to detecting the user selection of the first data item: identifying, based at least partially on a stored mapping between the first data item of the second application and a second data item of the first application, context data related to the user selection, and obtaining, from the first application, one or more navigation options associated with the context data; and causing presentation, within the embedded analytics user interface, of an interface element including the one or more navigation options.

In Example 19, the subject matter of Example 18 includes, wherein the one or more navigation options are provided via a navigation extension that is recorded for the first application by an extension framework, and the extension framework further records the navigation extension for each of a plurality of other applications that utilize the embedded analytics user interface.

In Example 20, the subject matter of any of Examples 18-19 includes, wherein the user selection is a first user selection, and the operations further comprise: detecting, via the embedded analytics user interface, a second user selection of a first navigation option from among the one or more navigation options presented within the embedded analytics user interface; and in response to detecting the second user selection, triggering navigation away from the embedded analytics user interface to a target destination associated with the first navigation option.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

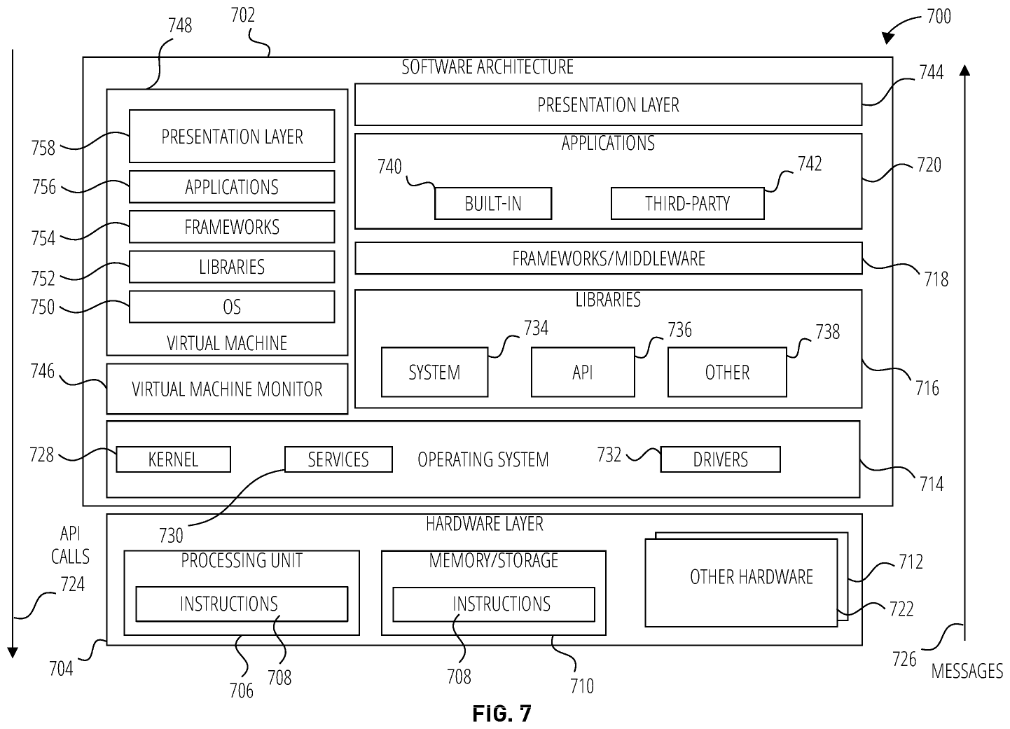

FIG. 7 is a block diagram 700 showing a software architecture 702 for a computing device, according to some examples. The software architecture 702 may be used in conjunction with various hardware architectures, for example, as described herein. FIG. 7 is merely a non-limiting illustration of a software architecture, and many other architectures may be implemented to facilitate the functionality described herein. A representative hardware layer 704 is illustrated and can represent, for example, any of the above referenced computing devices. In some examples, the hardware layer 704 may be implemented according to the architecture of the computer system of FIG. 8.

The representative hardware layer 704 comprises one or more processing units 706 having associated executable instructions 708. Executable instructions 708 represent the executable instructions of the software architecture 702, including implementation of the methods, modules, subsystems, and components, and so forth described herein and may also include memory and/or storage modules 710, which also have executable instructions 708. Hardware layer 704 may also comprise other hardware as indicated by other hardware 712 and other hardware 722 which represent any other hardware of the hardware layer 704, such as the other hardware illustrated as part of the software architecture 702.

In the architecture of FIG. 7, the software architecture 702 may be conceptualized as a stack of layers where each layer provides particular functionality. For example, the software architecture 702 may include layers such as an operating system 714, libraries 716, frameworks/middleware layer 718, applications 720, and presentation layer 744.

Operationally, the applications 720 or other components within the layers may invoke API calls 724 through the software stack and access a response, returned values, and so forth illustrated as messages 726 in response to the API calls 724. The layers illustrated are representative in nature and not all software architectures have all layers. For example, some mobile or special purpose operating systems may not provide a frameworks/middleware layer 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service. The interrupt service may detect the receipt of an interrupt and, in response, cause the software architecture 702 to pause its current processing and execute an interrupt service routine (ISR) when an interrupt is accessed.

The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 716 may provide a common infrastructure that may be utilized by the applications 720 or other components or layers. The libraries 716 typically provide functionality that allows other software modules to perform tasks in an easier fashion than to interface directly with the underlying operating system 714 functionality (e.g., kernel 728, services 730 or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks/middleware layer 718 may provide a higher-level common infrastructure that may be utilized by the applications 720 or other software components/modules. For example, the frameworks/middleware layer 718 may provide various graphic user interface (GUI) functions, high-level resource management, high-level location services, and so forth. The frameworks/middleware layer 718 may provide a broad spectrum of other APIs that may be utilized by the applications 720 or other software components/modules, some of which may be specific to a particular operating system or platform.

The applications 720 include built-in applications 740 or third-party applications 742. Examples of representative built-in applications 740 may include, but are not limited to, a contacts application, a browser application, a book reader application, a location application, a media application, a messaging application, or a game application. Third-party applications 742 may include any of the built-in applications as well as a broad assortment of other applications. In a specific example, the third-party application 742 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 742 may invoke the API calls 724 provided by the mobile operating system such as operating system 714 to facilitate functionality described herein.

The applications 720 may utilize built in operating system functions (e.g., kernel 728, services 730 or drivers 732), libraries (e.g., system libraries 734, API libraries 736, and other libraries 738), and frameworks/middleware layer 718 to create user interfaces to interact with users of the system. Alternatively, or additionally, in some systems, interactions with a user may occur through a presentation layer, such as presentation layer 744. In these systems, the application/module “logic” can be separated from the aspects of the application/module that interact with a user.

Some software architectures utilize virtual machines. In the example of FIG. 7, this is illustrated by virtual machine 748. A virtual machine creates a software environment where applications/modules can execute as if they were executing on a hardware computing device. A virtual machine is hosted by a host operating system (operating system 714) and typically, although not always, has a virtual machine monitor 746, which manages the operation of the virtual machine as well as the interface with the host operating system (e.g., operating system 714). A software architecture executes within the virtual machine 748 such as an operating system 750, libraries 752, frameworks/middleware 754, applications 756 or presentation layer 758. These layers of software architecture executing within the virtual machine 748 can be the same as corresponding layers previously described or may be different.

Certain examples are described herein as including logic or a number of components, modules, or mechanisms. Modules or components may constitute either software modules/components (e.g., code embodied (1) on a non-transitory machine-readable medium or (2) in a transmission signal) or hardware-implemented modules/components. A hardware-implemented module/component is a tangible unit capable of performing certain operations and may be configured or arranged in a certain manner. In examples, one or more computer systems (e.g., a standalone, client, or server computer system) or one or more hardware processors may be configured by software (e.g., an application or application portion) as a hardware-implemented module/component that operates to perform certain operations as described herein.

In various examples, a hardware-implemented module/component may be implemented mechanically or electronically. For example, a hardware-implemented module/component may comprise dedicated circuitry or logic that is permanently configured (e.g., as a special-purpose processor, such as a field programmable gate array (FPGA) or an application-specific integrated circuit (ASIC)) to perform certain operations. A hardware-implemented module/component may also comprise programmable logic or circuitry (e.g., as encompassed within a general-purpose processor or another programmable processor) that is temporarily configured by software to perform certain operations.

Accordingly, the term “hardware-implemented module” or “hardware-implemented component” should be understood to encompass a tangible entity, be that an entity that is physically constructed, permanently configured (e.g., hardwired), or temporarily or transitorily configured (e.g., programmed) to operate in a certain manner or to perform certain operations described herein. Considering examples in which hardware-implemented modules/components are temporarily configured (e.g., programmed), each of the hardware-implemented modules/components need not be configured or instantiated at any one instance in time. For example, where the hardware-implemented modules/components comprise, a general-purpose processor configured using software, the general-purpose processor may be configured as respective different hardware-implemented modules/components at different times. Software may accordingly configure a processor, for example, to constitute a particular hardware-implemented module/component at one instance of time and to constitute a different hardware-implemented module/component at a different instance of time.

Hardware-implemented modules/components can provide information to, and receive information from, other hardware-implemented modules/components. Accordingly, the described hardware-implemented modules/components may be regarded as being communicatively coupled. Where multiple of such hardware-implemented modules/components exist contemporaneously, communications may be achieved through signal transmission (e.g., over appropriate circuits and buses that connect the hardware-implemented modules/components). In examples in which multiple hardware-implemented modules/components are configured or instantiated at different times, communications between such hardware-implemented modules/components may be achieved, for example, through the storage and retrieval of information in memory structures to which the multiple hardware-implemented modules/components have access. For example, one hardware-implemented module/component may perform an operation, and store the output of that operation in a memory device to which it is communicatively coupled. A further hardware-implemented module/component may then, at a later time, access the memory device to retrieve and process the stored output.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules/components that operate to perform one or more operations or functions. The modules/components referred to herein may, in some examples, comprise processor-implemented modules/components.

Similarly, the methods described herein may be at least partially processor-implemented. For example, at least some of the operations of a method may be performed by one or more processors or processor-implemented modules/components. The performance of certain of the operations may be distributed among the one or more processors, not only residing within a single machine, but deployed across a number of machines.

The one or more processors may also operate to support performance of the relevant operations in a “cloud computing” environment or as SaaS. For example, at least some of the operations may be performed by a group of computers (as examples of machines including processors), these operations being accessible via a network (e.g., the Internet) and via one or more appropriate interfaces (e.g., APIs).

Examples may be implemented in digital electronic circuitry, or in computer hardware, firmware, or software, or in combinations of them. Examples may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

FIG. 8 is a block diagram of a machine in the example form of a computer system 800 within which instructions 824 may be executed for causing the machine to perform any one or more of the methodologies discussed herein. In alternative examples, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a GPU, or both), a primary or main memory 804, and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a UI navigation (or cursor control) device 814 (e.g., a mouse), a storage unit 816, a signal generation device 818 (e.g., a speaker), and a network interface device 820.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware.

The storage unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 or within the processor 802 during execution thereof by the computer system 800, with the main memory 804 and the processor 802 also each constituting a machine-readable medium 822.

While the machine-readable medium 822 is shown in accordance with some examples to be a single medium, the term “machine-readable medium” may include a single medium or multiple media (e.g., a centralized or distributed database, or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with such instructions 824. The term “machine-readable medium” shall accordingly be taken to include, but not be limited to, solid-state memories, and optical and magnetic media. Specific examples of a machine-readable medium 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 824 may further be transmitted or received over a communications network 826 using a transmission medium. The instructions 824 may be transmitted using the network interface device 820 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 824 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the subject matter may be referred to herein, individually or collectively, by the term “example” merely for convenience and without intending to voluntarily limit the scope of this application to any single example or concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. Except as otherwise indicated, the word “or” in reference to a list of two or more items, covers all of the following interpretations of the word: any one of the items in the list, all of the items in the list, and any combination of the items in the list.

Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

What is claimed is:

1. A system comprising:
at least one memory that stores instructions; and
one or more processors configured by the instructions to perform operations comprising:
causing presentation of an embedded analytics user interface within a first application, the embedded analytics user interface being provided by a second application and including a plurality of user-selectable data items of the second application;
detecting, via the embedded analytics user interface, a user selection of a first data item from among the plurality of user-selectable data items;
in response to detecting the user selection of the first data item:
identifying, based at least partially on a stored mapping between the first data item of the second application and a second data item of the first application, context data related to the user selection, and
obtaining, from the first application, one or more navigation options associated with the context data; and
causing presentation, within the embedded analytics user interface, of an interface element including the one or more navigation options.

2. The system of claim 1, wherein the one or more navigation options are provided via a navigation extension that is recorded for the first application by an extension framework, and the extension framework further records the navigation extension for each of a plurality of other applications that utilize the embedded analytics user interface.

3. The system of claim 1, wherein the user selection is a first user selection, and the operations further comprise:
detecting, via the embedded analytics user interface, a second user selection of a first navigation option from among the one or more navigation options presented within the embedded analytics user interface; and
in response to detecting the second user selection, triggering navigation away from the embedded analytics user interface to a target destination associated with the first navigation option.

4. The system of claim 3, wherein triggering the navigation away from the embedded analytics user interface comprises transmitting an instruction message to the first application to perform in-application navigation to the target destination, and the navigation causes presentation of a first application user interface of the first application that does not include the embedded analytics user interface.

5. The system of claim 3, wherein triggering the navigation away from the embedded analytics user interface comprises transmitting an instruction message to the first application to perform cross-application navigation to the target destination, and the navigation causes presentation of a third application user interface of a third application that does not include the embedded analytics user interface.

6. The system of claim 1, wherein the interface element comprises a menu presented within the embedded analytics user interface, and the operations further comprise:
dynamically populating the menu with the one or more navigation options obtained from the first application.

7. The system of claim 1, wherein the one or more navigation options are provided via a navigation extension that is recorded for the first application, and the one or more navigation options are obtained from the first application based on detection of the navigation extension.

8. The system of claim 7, the operations further comprising:
dynamically populating a menu within the embedded analytics user interface with a navigation extension element based on the detection of the navigation extension, the interface element being a submenu of the menu that presents the one or more navigation options in dependence on the navigation extension element.

9. The system of claim 1, wherein the stored mapping defines relationships between the plurality of user-selectable data items in the embedded analytics user interface and corresponding fields utilized by the first application.

10. The system of claim 1, wherein the second data item is a field identifier utilized by the first application.

11. The system of claim 10, wherein the context data comprises one or more of the field identifier, the first data item, a semantic object utilized by the first application, or a data source identifier associated with the first data item.

12. The system of claim 1, wherein the obtaining of the one or more navigation options comprises:
generating a payload that comprises the context data;
causing transmission, to the first application, of a request message that comprises the payload; and
accessing a response message from the first application that identifies the one or more navigation options, wherein the first application processes the payload of the request message to generate the one or more navigation options.

13. The system of claim 1, wherein the embedded analytics user interface presents the plurality of user-selectable data items in at least one of a table or a chart.

14. The system of claim 1, wherein the embedded analytics user interface is embedded within a section of the first application, and the embedded analytics user interface provides at least one of a report, a dashboard, or a data visualization within the section of the first application.

15. A method comprising:
causing presentation of an embedded analytics user interface within a first application, the embedded analytics user interface being provided by a second application and including a plurality of user-selectable data items of the second application;
detecting, via the embedded analytics user interface, a user selection of a first data item from among the plurality of user-selectable data items;
in response to detecting the user selection of the first data item:
identifying, based at least partially on a stored mapping between the first data item of the second application and a second data item of the first application, context data related to the user selection, and
obtaining, from the first application, one or more navigation options associated with the context data; and
causing presentation, within the embedded analytics user interface, of an interface element including the one or more navigation options.

16. The method of claim 15, wherein the one or more navigation options are provided via a navigation extension that is recorded for the first application by an extension framework, and the extension framework further records the navigation extension for each of a plurality of other applications that utilize the embedded analytics user interface.

17. The method of claim 15, wherein the user selection is a first user selection, and the method further comprises:
detecting, via the embedded analytics user interface, a second user selection of a first navigation option from among the one or more navigation options presented within the embedded analytics user interface; and
in response to detecting the second user selection, triggering navigation away from the embedded analytics user interface to a target destination associated with the first navigation option.

18. A non-transitory computer-readable medium that stores instructions that, when executed by one or more processors, cause the one or more processors to perform operations comprising:
causing presentation of an embedded analytics user interface within a first application, the embedded analytics user interface being provided by a second application and including a plurality of user-selectable data items of the second application;
detecting, via the embedded analytics user interface, a user selection of a first data item from among the plurality of user-selectable data items;
in response to detecting the user selection of the first data item:
identifying, based at least partially on a stored mapping between the first data item of the second application and a second data item of the first application, context data related to the user selection, and
obtaining, from the first application, one or more navigation options associated with the context data; and
causing presentation, within the embedded analytics user interface, of an interface element including the one or more navigation options.

19. The non-transitory computer-readable medium of claim 18, wherein the one or more navigation options are provided via a navigation extension that is recorded for the first application by an extension framework, and the extension framework further records the navigation extension for each of a plurality of other applications that utilize the embedded analytics user interface.

20. The non-transitory computer-readable medium of claim 18, wherein the user selection is a first user selection, and the operations further comprise:
detecting, via the embedded analytics user interface, a second user selection of a first navigation option from among the one or more navigation options presented within the embedded analytics user interface; and
in response to detecting the second user selection, triggering navigation away from the embedded analytics user interface to a target destination associated with the first navigation option.
